(19) United States
(12) Patent Application Publication
(10) Pub. No.: US 2016/0367845 A1
(43) Pub. Date: Dec. 22, 2016

(54) TEARING STRAP AND CORRESPONDING MANUFACTURING METHOD

(71) Applicant: ZEDEL, Crolles (FR)

(72) Inventor: Benoît BOUQUIER, Corenc (FR)

(73) Assignee: ZEDEL, Crolles (FR)

(21) Appl. No.: 15/153,071

(22) Filed: May 12, 2016

(30) Foreign Application Priority Data
May 12, 2015 (FR) 1554253

(51) Int. Cl. A62B 35/04

(52) U.S. Cl. CPC A62B 35/04

(57) ABSTRACT

The tearing strap is provided with first and second woven straps. Each of the first and second woven straps comprises at least one separation area where the first strap is mechanically separated from the second strap, at least one link area where the first strap and second strap are mechanically linked by a fusible thread woven in the first and second straps and configured to dissipate energy by breaking in case of dynamic use of the tearing strap, and at least one resistance area comprising at least one crossover of the first and second straps. The invention also relates to a safety attachment device provided with one such tearing strap.

### BACKGROUND OF THE INVENTION

The invention relates to a strap called “tearing strap” designed to be integrated in an energy absorber, itself designed to be integrated in a safety attachment device for movement of the user along a hand rail.

### STATE OF THE ART

In the field of mountaineering and working at height, energy absorbers are regularly used in order to ensure safety and comfort of the user in case of a fall. A known type of absorber is formed by a tearing strap 1.

In conventional manner illustrated in FIGS. 1A, 1B, 1C, 10 and 1E, two straps 2 and 3 are associated to form a tearing strap 1. The two straps 2 and 3 are linked on one or more portions by means of a fusible thread which will break and mechanically release the two straps. The two straps are arranged so as to form a strap ring after undergoing a stress.

The use of a strap ring ensures that the elements connected to the tearing strap remain secured after undergoing a stress. To obtain this strap ring, the two ends of the straps 2 and 3 are connected to one another by stitching to form the resistance areas which guarantee the strength of the strap ring.

FIGS. 2A, 2B, 2C, 2D, and 2E represent alternative embodiments of the devices illustrated in FIGS. 1A, 1B, 1C, 1D and 1E. Between these two alternative embodiments, only the resistance areas are modified. In the first embodiment, the resistance areas are advantageous for direct connection of a karabiner (FIGS. 1B and 2B) whereas the alternative embodiment (FIGS. 1B and 2B) is advantageous for stitching of a textile part which will apply the forces in case of a fall.

Different embodiments are known and used. An exemplary embodiment is described in International Patent application WO 98/41284, This particular embodiment is illustrated in FIGS. 3A and 3B. Two straps are mechanically connected at their ends by resistance areas which define the strap ring. Inside this strap ring, two link areas are formed to mechanically connect the two straps with a fusible thread. A separation area is arranged between these two link areas, where the two straps are free. These two portions of strap are used to connect the user on one side and the belaying point on the other side. In case of a fall, the two link areas are stressed until the resistance areas are reached.

An alternative embodiment consists in using a single link area. In another embodiment represented in FIGS. 1B and 1C, a tearing strap 1 is formed by two straps 2 and 3 which are first of all connected by means of fusible threads 4. Then the two straps 2 and 3 are twisted so that the end 2a of strap 2 and the end 3b of strap 3 on the one hand, and the end 3a of strap 3 and the end 2b of strap 2 on the other hand, are stitched by means of resistance threads 5. The tearing strap 1 is then arranged in the form represented in FIG. 1B.

In case of dynamic use, the forces (represented by the arrows in FIGS. 1B and 1C) exerted on the tearing strap have the effect of breaking the fusible threads 4 joining the straps 2 and 3. Breaking of the fusible threads 4 enables the shock undergone by the user when falling to be absorbed. At the outcome, the two straps 2 and 3 are completely separated except at the level of the stitching formed by means of the resistance threads 5. The broken fusible threads 4 are represented in FIGS. 1B and 1C by threads salient from the straps 2 and 3.

As illustrated in FIGS. 1B and 1C in comparison with FIGS. 1D and 1E, twisting of the two straps 2 and 3 is indispensable, otherwise it is impossible to stitch the ends 2a and 3b on the one hand and the ends 3a and 2b on the other hand and so as to end up by forming a strap ring. If the ends 2a and 2b and the ends 3a and 3b are stitched to one another as in FIG. 1D, the straps 2 and 3 come completely apart from one another and make the user fall in case of dynamic use (FIG. 1E). What is explained for the embodiments illustrated in FIGS. 1B, 1C, 1D and 1E is also true for the embodiments illustrated in FIGS. 2B, 2C, 2D and 2E.

It is apparent that known tearing straps are complicated to manufacture and therefore expensive as it is necessary to make sure that, after stressing, the strap ring will be formed and that it will be strong enough to support the user's fall.

The solidity of the stitching of the resistance threads is therefore fundamental, as it guarantees the safety of the user in case of dynamic use of the strap. To comply with safety standards, the stitching is very often made over a large length of the strap to prevent any tearing. This has the drawback of greatly limiting the flexibility of the strap and of increasing its size.

Another drawback is that making a twist of the straps 2 and 3 increases the size of the tearing strap 1 as a sufficient strap length is required to be able to let the head of the sewing machine pass when the strap is manufactured.

### OBJECT OF THE INVENTION

One object of the invention consists in providing a tearing strap that is more solid and/or more compact. For this purpose, the strap is provided with first and second woven straps. Each of the first and second woven straps comprises:
at least one separation area where the first strap is mechanically separated from the second strap,
at least one link area where the first strap and second strap are mechanically linked by a fusible thread woven in the first and second straps and configured to dissipate energy by breaking in case of dynamic use of the tearing strap,
one resistance area where the first and second straps are mechanically linked in permanent manner, the resistance area comprising at least one crossover of the first and second straps.

The at least one separation area can be separated from the resistance area by the at least one link area.

In advantageous manner, each of the first and second woven straps can have a free end, said free end being separated from the resistance area by the at least one link area.

The resistance area is also able to comprise at least two crossovers of the first and second straps.

In an alternative embodiment, the tearing strap can be provided with first and second woven straps, each of the first and second woven straps comprising:
at least one separation area where the first strap is mechanically separated from the second strap,
at least one link area where the first strap and second strap are mechanically linked by a fusible thread woven in the first and second straps and configured to dissipate energy by breaking in case of dynamic use of the tearing strap,
   at least first and second resistance areas where the first and second straps are mechanically linked in permanent manner, the first and/or the second resistance areas comprising at least one crossover of the first and second straps, the first and second resistance areas being separated by the at least one separation area and by the at least one link area.

In that case, the first resistance area can be separated from the at least one link area by the at least one separation area. The tearing strap can successively comprise the first resistance area, a first link area, a separation area and the second resistance area. An additional link area can be disposed between the separation area and the second resistance area.

In advantageous manner, the first and/or the second resistance area can comprise a plurality of crossovers where the first strap crosses the second strap.

The tearing strap can also comprise an additional crossover separated from the first and second resistance areas by respectively first and second link areas along each of the first and second straps, first and second link areas being separated by the additional crossover.

In addition, the at least one resistance area can be separated from the at least one crossover area by the at least one link area along at least one of the first and second straps.

Another object of the invention is to achieve a safety attachment device for movement of the user along a hand rail comprising a tearing strap as set out in the foregoing.

Another object of invention is a strap formed by weaving of the superposed first and second straps and comprising:
at least one crossover area where the first strap crosses the second strap,
at least one link area where the first strap and second strap are mechanically linked by a fusible thread woven in the first and second straps,
at least one separation area where the first strap is mechanically separated from the second strap.

The strap can in particular comprise a repetition pattern formed in repetitive manner, the repetition pattern comprising:
a first resistance area comprising at least one crossover where the first strap crosses the second strap,
a first link area where the first strap and the second strap are mechanically linked by a fusible thread woven in the first and second straps,
a separation area where the first strap is mechanically separated from the second strap.

The repetition pattern can comprise after the separation area an additional link area where the first strap and the second strap are mechanically linked by a fusible thread woven in the first and second straps.

In this case, the strap can successively comprise after the additional link area:
a second resistance area comprising at least one crossover where the first strap crosses the second strap,
a second separation area and/or an additional link area.

According to another alternative embodiment of the strap, the latter can comprise a repetition pattern successively comprising:
the separation area where the first strap is mechanically separated from the second strap,
the first link area where the first strap and the second strap are mechanically linked by a fusible thread woven in the first and second straps,
a crossover area where the first strap crosses the second strap,
an additional link area where the first strap and the second strap are mechanically linked by a fusible thread woven in the first and second straps.

### BRIEF DESCRIPTION OF THE DRAWINGS

Other advantages and features will become more clearly apparent from the following description of particular embodiments of the invention given for non-restrictive example purposes only and represented in the appended drawings, in which:

FIGS. 1A, 1B, 1C, 1D and 1E illustrate in schematic manner two embodiments of a tearing strap according to the prior art,

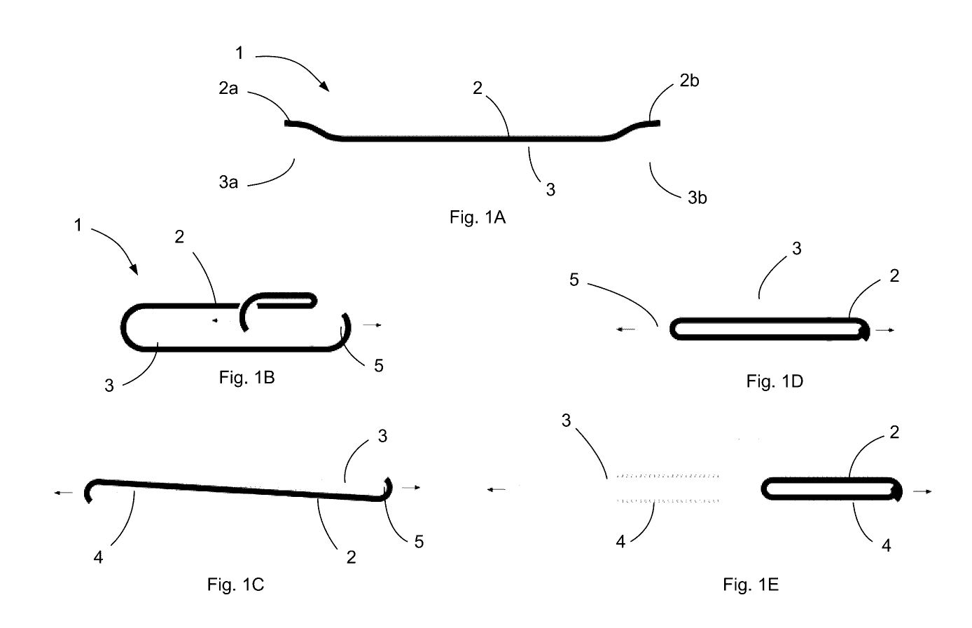

FIGS. 2A, 2B, 2C, 2D and 2E illustrate in schematic manner variants of embodiments of a tearing strap according to the prior art,

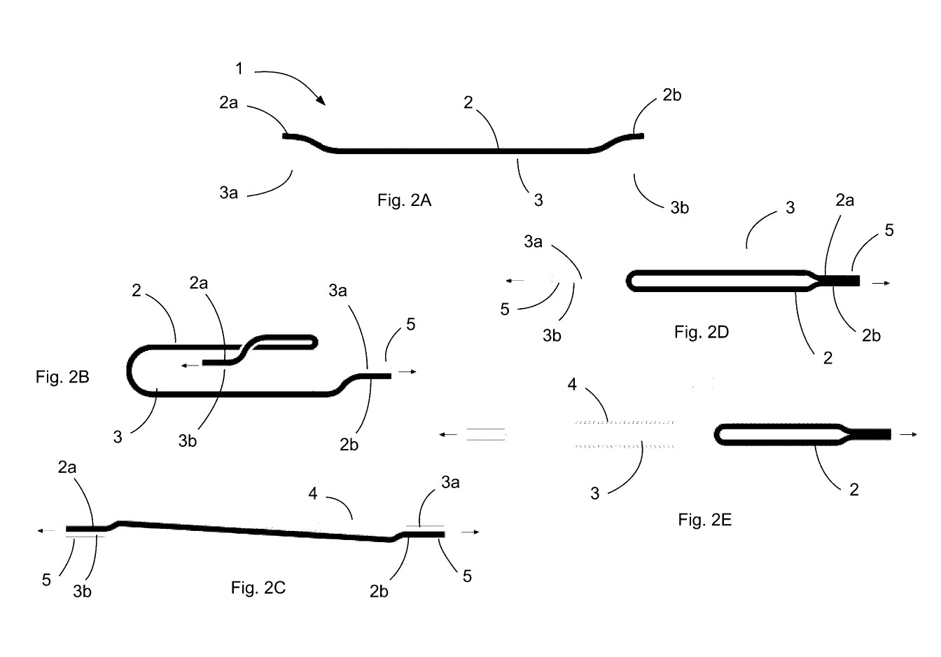

FIGS. 3A and 3B illustrate in schematic manner another embodiment of the tearing strap according to the prior art,

FIGS. 4A, 4B, 4C, and 4D represent a possible embodiment of the tearing strap,

FIGS. 5 and 6 present a longitudinal cross-sectional view of a detail of the tearing strap according to the invention for a strap with a single blanket or for a strap with two blankets,

FIGS. 7A and 7B illustrates another embodiment of the tearing strap according to the invention,

FIG. 8 illustrates a succession of different areas able to be made on one and the same strap,

FIG. 9 represents an alternative embodiment of the tearing strap illustrated in FIGS. 7A and 7B, but presenting a link area,

FIGS. 10 to 15 illustrate, in top view in schematic manner, several embodiments of a strap configured to form several tearing straps.

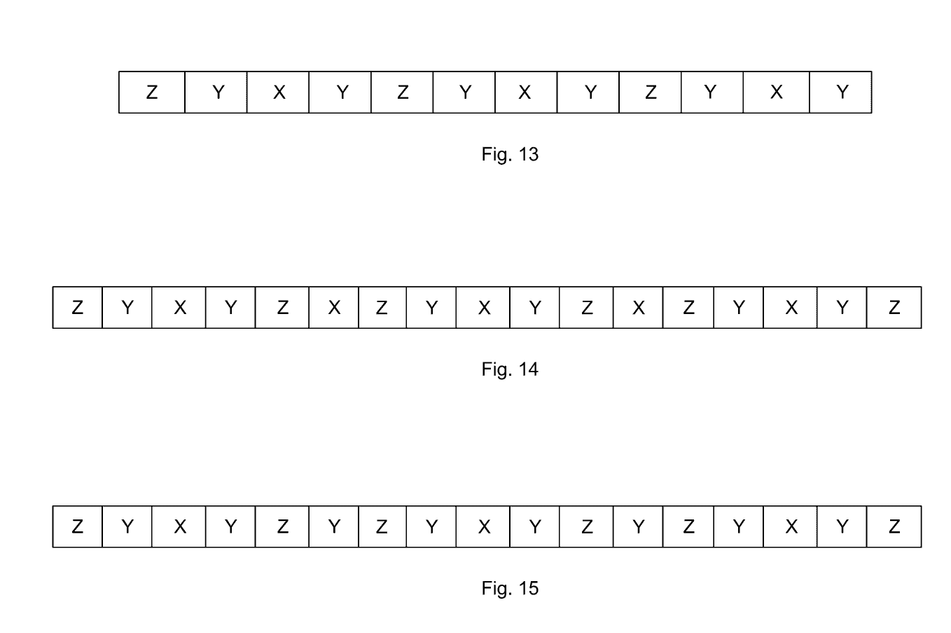

### DETAILED DESCRIPTION

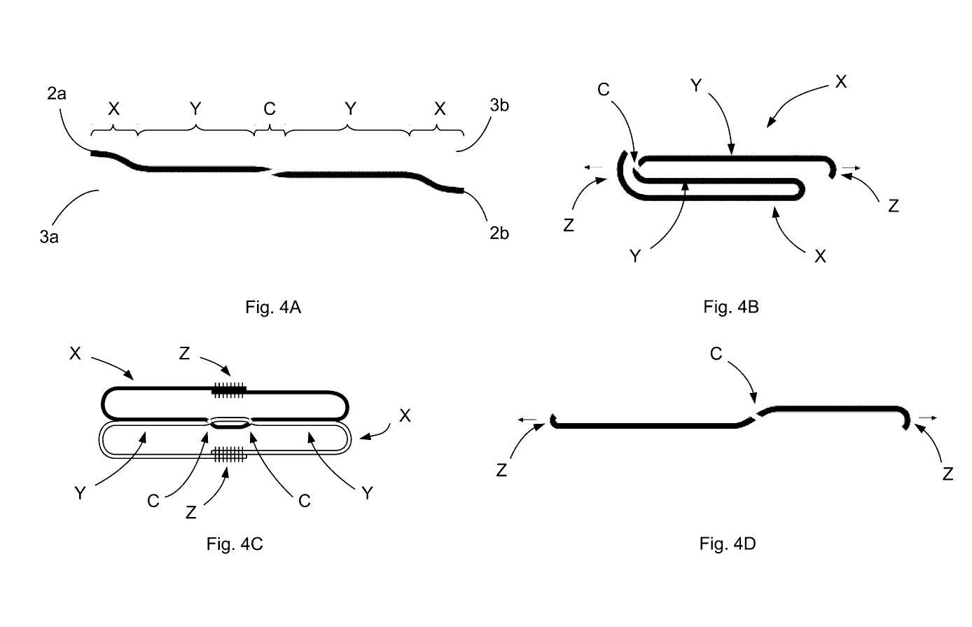

As illustrated in FIGS. 4A, 4B, 4C, and 4D, the tearing strap 1 comprises several different areas with different mechanical characteristics. The tearing strap comprises a separation area X where the first and second straps 2 and 3 are separated. In this separation area X, the first and second straps 2 and 3 are not mechanically linked. In certain embodiments, several separation areas X can exist. The separation area X can be the area where the tearing strap 1 is connected to the element to be protected (generally the user) and for example to a fixed point, a lifeline or in general manner a belaying point.

The tearing strap 1 comprises at least one link area Y where the first and second straps 2 and 3 are mechanically linked by means of a link thread 4 which is preferentially installed by weaving in the course of the weaving step of the two straps 2 and 3. In the link area Y, the two straps 2 and 3 are mechanically linked by the link thread 4, also called fusible thread, which will be stretched and will then break if the stress applied to separate the two straps 2 and 3 reaches a threshold value. It is breaking of the different link threads 4 which dissipates at least a part of the energy of the fall of the elements to be protected. In the tearing strap 1, the role of the fusible threads 4 is to dissipate the energy stored by the strap, by breaking, in case of dynamic use. As the fusible threads 4 progressively break, the two initially linked straps 2 and 3 become separated from one another.

The tearing strap 1 further comprises at least one crossover area C where the first strap 2 passes over the second strap 3. The first and second straps 2 and 3 cross so that the order of superposition of the two straps is different on each side of the crossover area C. Each crossover area corresponds to a permanent connection area between the two straps 2 and 3.

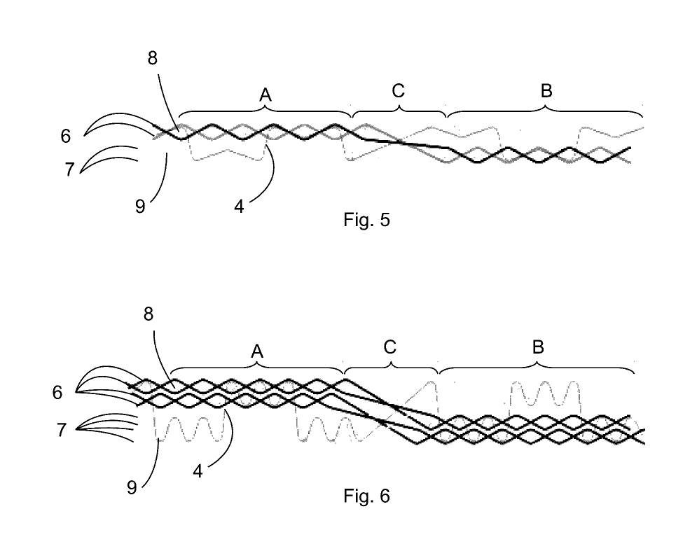

As illustrated in FIGS. 5 and 6 for example purposes, the tearing strap comprises first warp threads 6 and second warp threads 7 and first weft threads 8 and second weft threads 9 to form the straps 2 and 3. In the embodiment illustrated in FIG. 5, strap 2 and strap 3 are each formed by a single blanket. In the embodiment of FIG. 6, the straps 2 and 3 are each formed by two blankets, for example by a tubular strap.

FIGS. 5 and 6 each illustrate the succession of three areas A, C and B.

In a first area A, the first strap 2 is formed by the first warp threads 6 and the first weft threads 8, and in a second area B the first strap 2 is formed by the first warp threads 6 and the second weft threads 9.

In opposite manner, in the first area A, the second strap 3 is formed by the second warp threads 7 and the second weft threads 9, and in a second area B, the second strap 3 is formed by the second warp threads 7 and the first weft threads 8.

In the crossover area C situated between the first and second areas A and B, the first and second warp threads 6 and 7 cross one another. In the first area A, the first strap 2 is situated above the second strap 3, whereas in the second area B, it is situated below the second strap 3. In the illustrated example, the two straps are mechanically linked in areas A and B which each represent link areas Y by means of the link thread 4.

The embodiment illustrated in FIGS. 5 and 6 represents for example what is used to form the tearing strap of FIG. 4. As a variant, it is possible to only form a link area in area A or in area B or in neither of areas A and B. In order not to form a link area 4, it is possible to link the link thread 4 with one of the straps 2 or 3 only, and to leave the link thread 4 between the two straps 2 and 3. If the straps 2 and 3 are double straps as illustrated in FIG. 6, it is possible to isolate the link thread 4 between the two blankets of strap 2 or of strap 3.

The tearing strap 1 also comprises a resistance area Z where the two straps 2 and 3 are mechanically linked. The resistance area Z is configured to guarantee the mechanical connection between the two straps 2 and 3 after stressing and breaking of the link thread 4. Depending on the embodiments, the resistance area Z can be the area where the forces are applied when a fall takes place—it is for example the attachment area of connectors such as karabiners.

As in the prior art, the tearing strap 1 is configured so that after breaking of the link thread 4, the two straps 2 and 3 remain attached to one another by means of the resistance areas Z to form a strap ring which secures the connectors mechanically connected to the element to be protected and to a fixed or movable point. As illustrated in FIG. 4C, after breaking, the broken link threads 4 are represented by threads salient from straps 2 and 3.

In the embodiment illustrated in FIGS. 4A, 4B and 4C, two resistance areas Z and one crossover area C between these two resistance areas Z are formed. There is therefore a permanent connection area between the two resistance areas Z.

In the illustrated configuration, each of the two resistance areas Z is separated from the crossover area C by at least one link area Y. There is then the link area Y completed by an additional link area Y. Depending on the embodiments, one link area Y or several link areas Y separated by a separation area X can be used between the resistance area and the crossover area C.

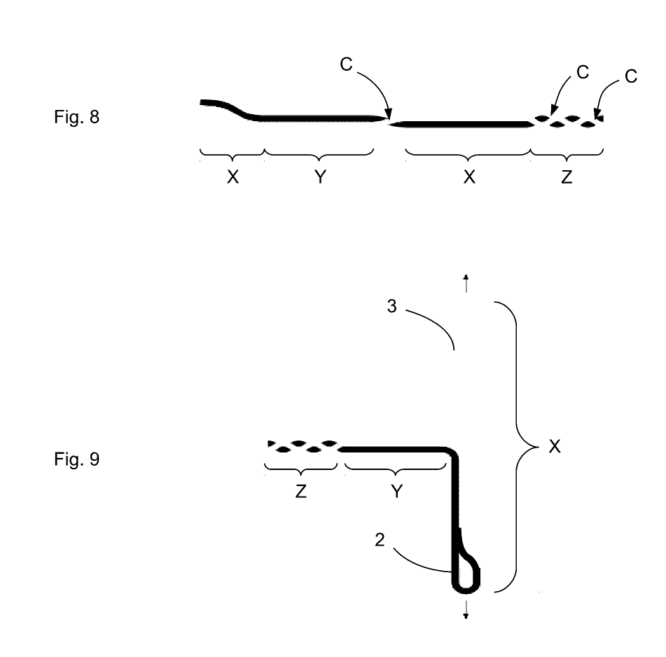

However, as a variant illustrated in FIG. 8, a single link area can be used but this embodiment is less advantageous as the connector tends to move along the strap as traction progressively takes place.

In the embodiment of FIG. 4, it is particularly advantageous to use the resistance areas Z as attachment area of the connectors connected to the user and to the belaying point.

As indicated in the foregoing, when a fall occurs, a traction force (represented by the arrows in FIGS. 4B and 4C) appears between the two straps 2 and 3, and when the force exceeds a threshold value, the fusible threads 4 deform up to their breaking threshold. Once the breaking threshold has been reached, they break and stress the following fusible threads 4. As the fall progresses, the straps 2 and 3 separate in the link areas Y by breaking of the fusible threads 4. When breaking, the fusible threads 4 dissipate the stored energy and slow down the user's fall. When all the fusible threads 4 have yielded (FIG. 4C), the warp and weft threads of the straps 2 and 3 and the resistance areas Z form the strap rings securing the user.

It can be observed in the embodiment illustrated in FIG. 4C that, after stressing of the tearing strap 1 beyond the breaking threshold of the fusible threads 4, two distinct strap rings are formed. These two strap rings are mechanically connected by means of the crossover area C and resistance areas Z. The crossover area C separates the two strap rings.

In the embodiment illustrated in FIG. 4B, the resistance areas Z are formed by a stitching of a resistance thread which connects the two ends of the straps and defines the future strap rings.

This embodiment is particularly advantageous as the crossover area C is achieved when weaving of the straps is performed, which ensures a large repeatability. Crossover is then performed automatically by the loom instead of an operator who might forget to make the twist of the prior art following an unexpected stress. The risk of manufacturing a non-compliant tearing strap 1 is therefore greatly reduced.

In this configuration, it is advantageous to make resistance areas Z which are each formed by one end of the first strap 2 and by one end of the second strap 3.

The first and second straps 2 and 3 each comprise a first end 2a and 3a arranged on the first side of the crossover area C and opposite second ends 2b and 3b arranged on a second side of the crossover area C. The first end 2a of the first strap 2 is connected to the second end 3b of the second strap 3 to form a first resistance area Z. The first resistance area Z is advantageously formed by a resistance thread (not shown) which is stitched.

The second end 2b of the first strap 2 is connected to the first end 3a of the second strap 3 to form a second resistance area Z. The second resistance area Z is advantageously formed by a resistance thread which is stitched. The resistance threads are present to connect the ends of the straps 2 and 3 and are configured so as not to break in case of the user falling.

This configuration is advantageous as it is easy to achieve. FIG. 5 illustrates two straps 2 and 3 connected by a crossover area C and by two areas A and B. The two straps are superposed with a top strap and a bottom strap. To form the tearing strap 1, it is advantageous to connect the two top straps to form a resistance area Z and to connect the two bottom straps to form the other resistance area Z. This configuration is simple to achieve which reduces the risks of error.

However, it is observed that if the resistance areas are formed by the two ends of the same strap 2 or 3, after stressing, two strap rings will be formed. These two strap rings will be connected by means of the crossover area C which enables the user to be kept secured to his belaying point. The use of a crossover area C prevents any error in formation of the resistance areas.

In the illustrated configuration, each link area Y is separated from the resistance area Z by a separation area X. It is also possible to provide for only one of the resistance areas Z to be separated from its nearest link area Y by means of a separation area X. It is further possible to provide for the resistance area Z to be in contact with the link area Y, but this configuration is more difficult to achieve in industrial manner.

In this configuration, it is possible not to use a twist on one of the two straps to ensure formation of a strap ring when stressing of the tearing strap 1 takes place beyond the breaking threshold of the link threads 4. Furthermore, it is also advantageous to manufacture more compact straps by making a tearing strap 1 without a twist.

This embodiment is particularly easy to detect if the two straps used present different colours or patterns. The crossover area is manifested by a change of colour or pattern of the top or bottom strap. If this signature is not present on the strap, the operator immediately detects that the strap is not configured to achieve the tearing strap.

In an alternative embodiment illustrated in FIG. 4C, the crossover area can be formed by several successive crossover areas.

As indicated in the foregoing, it is possible to achieve two crossovers of the two straps 2 and 3, for example two crossovers or two crossover areas. In advantageous manner, the two crossover areas are separated by a separation area to give flexibility to the superposition of the straps. As a variant, it is possible to connect the two straps 2 and 3 between the two crossover areas C, this mechanical connection not being used in operation of the tearing strap 1.

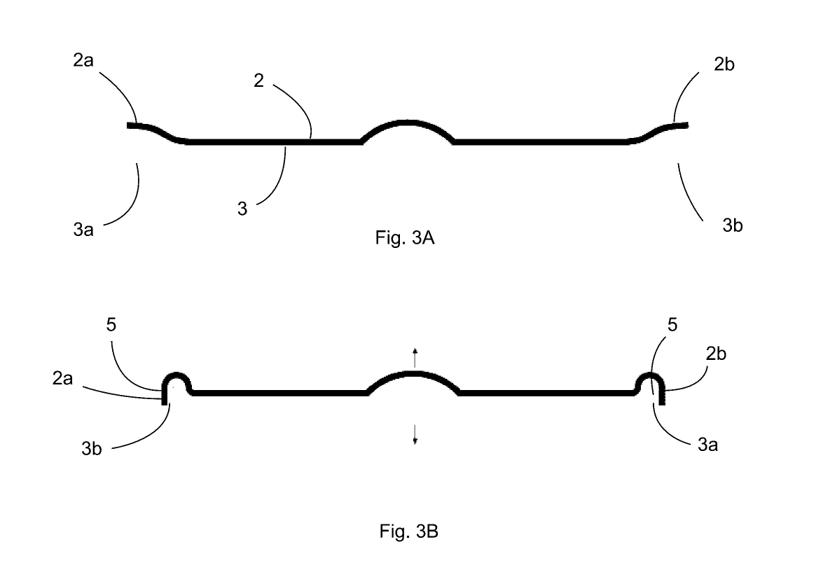

In this configuration illustrated in FIG. 3C, the top strap of the two superposed straps is the same outside the crossover area C defined by the two consecutive crossovers, for example strap 2.

As for the previous embodiment, two resistance areas Z and at least one link area Y of straps 2 and 3 are formed.

The first resistance area Z is formed by the mechanical connection of the two ends of the first strap 2. The second resistance area Z is formed by the mechanical connection of the two ends of the second strap 3.

As for the previous embodiment, it is not necessary to make a twist on at least one of the straps to form a strap ring after stressing. However, a twist can be made but the tearing strap will be less compact. It is therefore advantageous to make a strap without a twist.

If the two straps used have different colours or patterns, it is easy to ensure that the crossovers have been made. The risk of error on formation of the resistance areas is also reduced.

In this embodiment, after stressing, the first strap 2 forms a first strap ring and the second strap 3 forms a second strap ring. The two strap rings are mechanically connected by the crossover areas C. As for the previous embodiment, connection of the two different straps to form the resistance areas Z is not detrimental as the strap rings formed after stressing are secured by the crossover areas.

What has been described for a crossover area C with one crossover can be used for an odd number of crossovers C. What has been described for two crossovers can be used for an even number of crossovers. However, to achieve a gain in compactness, it is advantageous to keep a reduced number of crossovers.

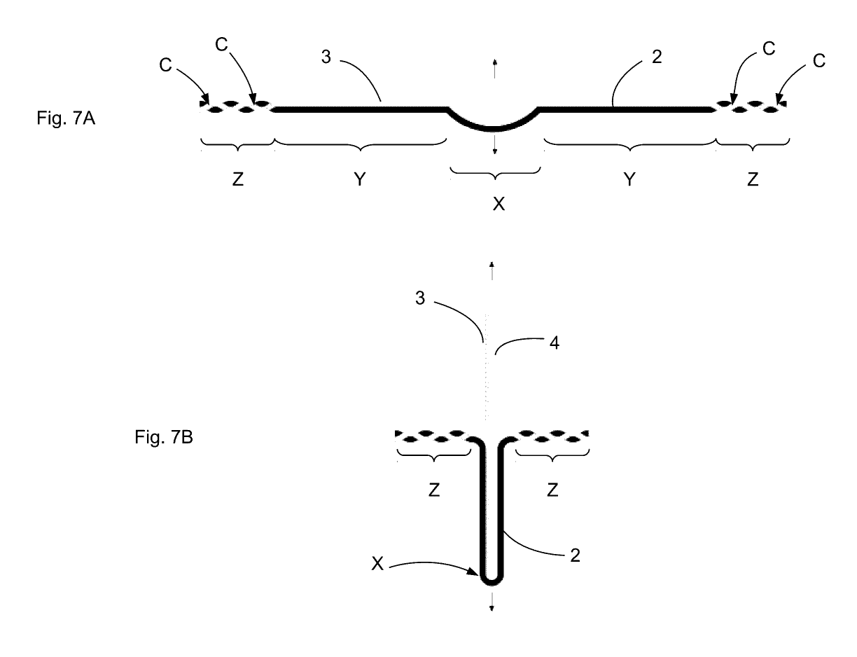

In an alternative embodiment illustrated in FIGS. 7A and 7B and 8, the crossover area C is formed by at least one crossover and forms a resistance area. Preferably, the crossover area C comprises at least two or three successive crossovers to increase the mechanical strength.

Advantageously, to form a resistance area, it is advantageous to make at least two successive crossovers separated by a separation area or by a link area.

The second resistance area can be formed by a crossover area comprising one or more crossovers or by a stitching as in the prior art.

If the two resistance areas are formed by two crossover areas, these two areas can be made with the same number of crossovers or with different numbers of crossovers.

In comparison with a resistance area made by stitching, the resistance area made by crossover is more repeatable as it is manufactured by the loom.

In general manner, the two resistance areas Z are separated by at least two link areas Y. As a variant, it is also possible to separate the two resistance areas Z by a single link area. The connectors then tend to move along the strap as the link thread progressively breaks. In the configuration illustrated in FIG. 7, the two link areas Y are separated by a separation area X. This separation area X is used to connect the user and the belaying point. In this configuration, the forces are applied through the separation area X in the event of the user falling.

The space between the traction force application area and the link area Y is devoid of any permanent mechanical contact between the two straps, i.e. there is no other resistance area Z or crossover area C.

In case of a fall, this permanent contact area would in fact prevent stressing of the link area Y which is unable to dissipate the energy of the fall.

In this way, using resistance areas by crossover, the two straps 2 and 3 are intrinsically linked in the resistance areas Z without stitching being necessary, which enables its strength to be notably increased while at the same time guaranteeing its flexibility.

In a particular embodiment, the crossovers may form several loops. This consequently enhances the solidity of the tearing strap 1 even further. As represented in FIG. 4, the length of each strap 2 and 3 between two consecutive crossovers can be equal.

FIG. 8 illustrates the succession of different areas on a strap, in side view. These are successively a separation area where the two straps are mechanically separated, a link area Y, the crossover area C, a new link area and then a resistance area formed by one or more crossovers.

These embodiments are particularly advantageous as the tearing strap is partially or completely formed by the loom which consecutively defines the resistance areas by crossing the straps, and the link areas by connecting the straps with the link thread and the separation areas. The final mechanical connection is performed by the crossover area formed by the loom.

A strap called primary strap is formed by superposition of the two straps 2 and 3 by means of a loom. This loom will define a repetition pattern which will be made in repetitive manner all along the primary strap. The repetition pattern comprises:
at least a first resistance area formed by a crossover between the first and second straps and where the first and second straps 2 and 3 are mechanically linked in permanent manner,
a link area Y where the first strap 2 and second strap 3 are mechanically linked by a fusible thread 4 woven in the first and second straps 2 and 3 and configured to dissipate the energy by breaking in case of dynamic use of the tearing strap 1,
a separation area where the first strap 2 is mechanically separated from the second strap 3.

In this way, several tearing straps can be woven consecutively in the primary strap.

The primary strap can be cut to form the ready-for-use tearing strap or to form a tearing strap before formation of at least one of the resistance areas by stitching. The link areas Y, crossover areas C and separation areas X are already defined and placed in the strap.

To form a tearing strap as illustrated in FIGS. 4A-4D, it is advantageous to form a repetition pattern which successively presents a separation area X, a first link area Y, a crossover area C and a second link area Y. It is then advantageous to cut the primary strap inside the separation areas X. If the strap is formed by the above-mentioned repetition pattern, cutting in the separation areas X enables a strap similar to the one illustrated in FIG. 4A to be formed.

It is also possible to complete the repetition pattern by link areas Y, separation areas X, and additional crossover areas C.

It is also advantageous to completely form the tearing strap 1 using the loom so as to avoid subsequent stitching steps.

To form such a tearing strap, as illustrated in schematic manner in FIG. 12, the repetition pattern can in consecutive manner be:
a first resistance area Z formed by one or more strap crossover areas,
a first link area Y,
a separation area X.

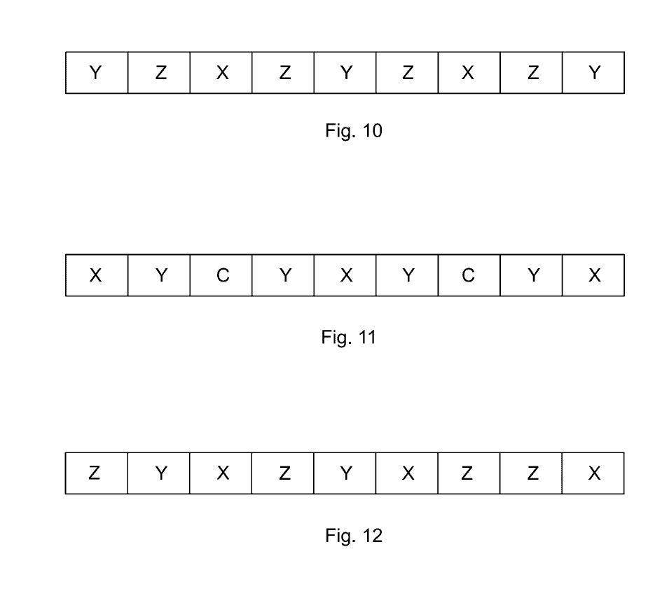

This embodiment illustrated in FIG. 9 enables a tearing strap as illustrated in FIGS. 7A and 7B to be formed but with a single link area Y. The connectors respectively′ connected to strap 2 and to strap 3 move progressively along the straps as the user falls. If the absorber is only formed by these three areas, it is advantageous to secure the connectors to each of the straps in the separation area X to form a compact absorber.

As a variant, to form the tearing strap 1 illustrated in FIGS. 7A and 7B, the repetition pattern can comprise a second link area Y which is separated from the first link area Y by the separation area X. This embodiment is illustrated in FIG. 13. The length of the first link area can be different from the length of the second link area, but it is advantageous to have two identical lengths to facilitate the work of the tearing strap. A second resistance area is also formed.

If the resistance area is formed by several crossovers, it is possible to cut the primary strap inside the resistance area so as to form the resistance areas Z of the two ends of the tearing strap 1. In other words, the stitching is advantageously made in such a way as to leave at least one crossover and preferably several crossovers on each side of the cutting area. These different crossover areas C will form the resistance areas Z of two successive tearing straps. In advantageous manner, the strap is hot cut so as to prevent fraying of the strap. After cutting, soldering of the strap is preferentially performed on the cut to enhance the strength.

If the resistance area Z is formed by a single crossover, a second resistance area has to be formed in the repetition pattern. The two resistance areas Z are separated by at least another area which can be of any type.

For example purposes, this additional pattern can be a second separation area and/or an additional link area Y. However, this embodiment can be less compact.

As a variant, the loom will successively and in repetitive manner define:
a first resistance area Z formed by several crossover areas C,
a first link area Y,
a separation area X,
a second link area Y,
a second resistance area Z formed by several crossover areas C,
a second separation area X and/or an additional link area Y.

These embodiments are illustrated in schematic manner in FIGS. 14 and 15.

To form the tearing strap 1, the primary strap is cut in two consecutive second separation areas and/or a third link area. The crossover areas C formed on each side of the cutting area will define the resistance areas Z of the tearing straps.

This embodiment is particularly advantageous as the tearing straps 1 can be made by a loom with a reduced human intervention. The tearing straps are finalised by cutting the primary strap, i.e. again with reduced human intervention.

By changing the intertwining of the threads between the different areas, it is possible to define the different mechanical properties sought for. The link thread 4 is present in the separation areas X and in the crossover areas C, but its positioning does not mechanically have any influence. The tearing strap 1 can be completely defined by the loom.

As indicated in the foregoing, to form the link areas Y, the straps 2 and 3 are connected by means of at least one link thread 4. An exemplary embodiment is illustrated for a flat strap and for a tubular strap (FIGS. 5 and 6). FIG. 5 illustrates an embodiment representing crossover of two flat straps. However, it is also possible to perform crossing of two tubular straps as illustrated in FIG. 6. The link thread 4 connects weft threads of the strap 2 with weft threads of the strap 3. In the separation area X, the link threads are arranged only in the strap 2 and/or in the strap 3 without making a connection between the two straps 2 and 3. Although the link thread 4 is present, it does not serve the purpose of keeping the two straps in contact.

Given that the safety attachment device can be used in the scope of dynamic use, it is advantageous to provide for two straps 2 and 3 to present identical mechanical characteristics, and preferably the same Young's modulus. One means of achieving this is to manufacture straps provided with both identical warp threads and identical weft threads.

In a particular embodiment, the first and second warp threads 6 and 7 are identical both as far as their material and the number of threads used are concerned. However it is possible to provide for the first and second warp threads 6 and 7 to be different as far as their mechanical performances are concerned. In this case, the number of first warp threads 6 can be different from the number of second warp threads 7, so as to obtain similar mechanical properties.

To have an identical mechanical behaviour over the whole length of the straps 2 and 3, it is also advantageous to have a first weft material identical to the second weft material.

The first and second warp threads 6 and 7 and the first and second weft threads 8 and 9 can advantageously be formed with the same type of thread, i.e. threads made from the same material and having the same diameter.

Having two straps 2 and 3 woven from identical warp and weft threads advantageously enables a good distribution of the forces to be ensured in case of dynamic use of the tearing strap 1.

According to a first embodiment, the warp threads 6 and 7 and weft threads 8 and 9 can be made from materials presenting a low Young's modulus so as to dissipate a part of the energy stored by the energy absorber during dynamic use. The materials can be chosen from polyester, polyamide or polypropylene.

It is also possible to use a very rigid warp threads 6 and 7 and weft threads 8 and 9 so as to prevent oscillations of the user during his fall. What is meant by rigid is that the threads can have a Young's modulus of more than 40 GPa.

The straps 2 and 3 can also comprise very rigid warp threads 6 and 7, and weft threads 8 and 9 that are less rigid. The warp threads can for example be formed by threads having a Young's modulus of more than 40 GPa, whereas the weft threads can be less rigid and are for example made from polyester, polyamide or polypropylene.

The tearing strap 1 can advantageously be integrated in a safety attachment device (not shown) for the user to be able to move along a hand rail, for example in a via ferrata lanyard.

The invention also relates to the method enabling tearing straps 1 to be manufactured comprising straps 2 and 3 which cross over one another.

For this, the first and second straps 2 and 3 are first of all simultaneously woven in the first area A by two looms placed one above the other. The first strap 2 is woven from the first warp threads 6 and first weft threads 8 by means of a first loom (not shown), and the second strap 3 is woven with second warp threads 7 and second weft threads 9 by means of a second loom (not shown).

The first and second warp threads 6 and 7 are then criss-crossed (formation of area C) so that the first warp threads 4 are associated with the second weft threads 9 in the second loom to form the first strap 2, and the second warp threads 7 collaborate with the first weft threads 8 in the first loom to form the second strap 3. The second area B of straps 2 and 3 is then woven.

In a particular embodiment, the weaving is stopped to enable crossover of the first and second warp threads 6 and 7. Stopping of the weaving corresponds to formation of the third area C of the tearing strap 1. When the warp threads are correctly crossed, the weaving can then restart to form the first and second straps 2 and 3 in the second area B.

This manufacturing method presents the advantage of guaranteeing the strength of the tearing strap 1 despite crossing of the first and second warp threads 6 and 7. However, stopping of the weaving increases the manufacturing time of the tearing strap 1.

To remedy this problem, another technique can be to slow down the weaving speed and to increase the distance between the consecutive warp threads.

As for the first embodiment mode of the manufacturing method of the tearing strap 1, in the first area A, the first strap 2 is woven by means of the first warp threads 6 and first weft threads 8. The second strap 3 is woven by means of the second warp threads 7 and second weft threads 9. Weaving of each strap is performed at the speed V1. The distance separating two first warp threads 6 or two second warp threads 7 is noted D1.

The weaving speed is then reduced to a speed V2 lower than the speed V1, and the distance between the first warp threads 6 and the second warp threads 7 is increased to the distance D2 that is greater than D1. The reduction of the weaving speed can be performed before or after increasing the distance between the warp threads. These two steps can also be performed in simultaneous manner.

Reducing the weaving speed and increasing the distance between the warp threads enables the warp threads to be crossed by positioning them in correct manner. This means for example that each first warp thread 6 takes the place of a second warp thread 7 when the first and second warp threads 6 and 7 are made with the same type of threads. These steps of reducing the weaving speed and increasing the distance between the threads enable the crossover area C of the tearing strap 1 to be achieved.

After the step of crossing of the first and second warp threads 6 and 7, the first warp threads 6 collaborate with the second weft threads 9 and the second warp threads 7 collaborate with the first weft threads 8 so as to form the second area B of the tearing strap 1.

The distance between two consecutive warp threads is then reduced to a value lower than D2, preferably to the value D1 chosen for weaving the straps 2 and 3 in the first area A. The weaving speed is then increased to a value greater than V2, preferably to the value D1. Increasing the weaving speed and reducing the distance between the warp threads can be performed simultaneously or consecutively in any order.

It is preferable for the weaving speed and the distance between the warp threads to be identical in the first and second areas A and B to guarantee the homogeneity of weaving of the tearing strap 1, and therefore its mechanical properties.

Increasing the distance between the warp threads in the third area C facilitates crossover of the warp threads.

Crossover in the middle of a link area in a configuration close to that of FIG. 4A can also be facilitated by a slight advance of the warp without laying-in.

Weaving the two straps simultaneously also prevents risks of stitching two straps having different, or even incompatible, mechanical properties. This guarantees a better control of the quality of the tearing strap 1 when manufacturing the latter.

It can also be noted that the simultaneous use of two looms enables one or more fusible threads (not shown) to be woven directly when manufacturing of the first and second straps 2 and 3 is performed so as to connect them mechanically. However the invention is not limited to this embodiment. It is quite possible to stitch the fusible thread after the straps have been woven.

1. Tearing strap provided with first and second woven straps, each of the first and second woven straps comprising:
at least one separation area where the first strap is mechanically separated from the second strap,
at least one link area where the first strap and second strap are mechanically linked by a fusible thread woven in the first and second straps and configured to dissipate energy by breaking in case of dynamic use of the tearing strap,
one resistance area where the first and second straps are mechanically linked in permanent manner, the resistance area comprising at least one crossover of the first and second straps.

2. Tearing strap according to claim 1, wherein the at least one separation area is separated from the resistance area by the at least one link area.

3. Tearing strap according to claim 1, wherein each of the first and second woven straps has a free end, said free end being separated from the resistance area by the at least one link area.

4. Tearing strap according to claim 1, wherein the resistance area comprising at least two crossovers of the first and second straps.

5. Tearing strap provided with first and second woven straps, each of the first and second woven straps comprising:
at least one separation area where the first strap is mechanically separated from the second strap,
at least one link area where the first strap and second strap are mechanically linked by a fusible thread woven in the first and second straps and configured to dissipate energy by breaking in case of dynamic use of the tearing strap,
at least first and second resistance areas where the first and second straps are mechanically linked in permanent manner, the first and/or the second resistance area comprising at least one crossovers of the first and second straps, the first and second resistance areas being separated by the at least one separation area and by the at least one link area.

6. Tearing strap according to claim 5, wherein the first resistance area is separated from the at least one link area by the at least one separation area.

7. Tearing strap according to claim 6, successively comprising the first resistance area, a first link area, a separation area and the second resistance area.

8. Tearing strap according to claim 7, wherein an additional link area is disposed between the separation area and the second resistance area.

9. Tearing strap according to claim 5, wherein the first and/or the second resistance area comprise a plurality of crossovers where the first strap crosses the second strap.

10. Tearing strap according to claim 5, comprising an additional crossover separated from the first and second resistance areas by respectively first and second link areas along each of the first and second straps, first and second link areas being separated by the additional crossover.

11. Tearing strap according to claim 5, wherein the at least one resistance area is separated from the at least one crossover area by the at least one link area along at least one of the first and second straps.

12. Safety attachment device for movement of a user along a hand rail comprising a tearing strap according to claim 1.

13. Safety attachment device for movement of a user along a hand rail comprising a tearing strap according to claim 5.

14. Strap formed by weaving of superposed first and second straps and comprising:
at least one crossover where the first strap crosses the second strap,
at least one link area where the first strap and second strap are mechanically linked by a fusible thread woven in the first and second straps,
at least one separation area where the first strap is mechanically separated from the second strap.

15. Strap according to claim 14, comprising a repetition pattern formed in repetitive manner, the repetition pattern successively comprising:
a first resistance area comprising at least one crossover where the first strap crosses the second strap,
a first link area where the first strap and second strap are mechanically linked by a fusible thread woven in the first and second straps,
a separation area where the first strap is mechanically separated from the second strap.

16. Strap according to claim 15, wherein the repetition pattern comprises after the separation area:
an additional link area where the first strap and second strap are mechanically linked by a fusible thread woven in the first and second straps.

17. Strap according to claim 16, wherein the repetition pattern comprises after the additional link area:
a second resistance area comprising at least one crossover where the first strap crosses the second strap,
a second separation area and/or an additional link area.

18. Strap according to claim 14, wherein the repetition pattern successively comprises:
the separation area where the first strap is mechanically separated from the second strap,
the first link area where the first strap and second strap are mechanically linked by a fusible thread woven in the first and second straps,
a crossover area where the first strap crosses the second strap,
a additional link area where the first strap and second strap are mechanically linked by a fusible thread woven in the first and second straps.
